(19) United States
(12) Patent Application Publication
(10) Pub. No.: US 2018/0286130 A1
(43) Pub. Date: Oct. 4, 2018

(54) GRAPHICAL IMAGE AUGMENTATION OF PHYSICAL OBJECTS

(71) Applicant: Hewlett-Packard Development Company, L.P., Fort Collins, CO (US)

(72) Inventors: Young Hoon Hoo Lee, Palo Alto, CA (US); Daniel G Gelb, Palo Alto, CA (US)

(21) Appl. No.: 15/764,632

(22) PCT Filed: Jan. 2, 2016
(86) PCT No.: PCT/US2016/012364

§ 371 Date: Mar. 29, 2018

(51) Int. Cl. G06T 19/00; G06T 7/194; G06T 7/73; G06T 7/60; G06T 7/536; G06T 7/90; G06T 7/246; G06T 15/08; G06T 17/20; G06T 15/40

(52) U.S. Cl. CPC G06T 19/006; G06T 7/194; G06T 7/75; G06T 7/60; G06T 7/536; G06T 7/90; G06T 2207/10024; G06T 15/08; G06T 17/20; G06T 15/40; G06T 2215/16; G06T 2207/10028; G06T 7/251

(57) ABSTRACT

A non-transitory computer readable medium includes computer executable instructions configured to generate an object model from image data captured from a physical object. The object model includes data representing location and geometry of the physical object. The instructions generate an augmentation model that includes data representing a graphical image and location information thereof with respect to the physical object in response to a user interaction associated with the physical object. The instructions map the augmentation model to the object model such that the graphical image of the augmentation model is spatially linked to the physical object.

### BACKGROUND

Virtual reality systems can be referred to as immersive multimedia or computer-simulated reality. Such systems replicate an environment that simulates a physical presence in places in the real world or an imagined world, allowing the user to interact in that world. These systems artificially create sensory experiences, which can include sight, hearing, touch, and smell, Some virtual realities generated from the systems are displayed either on a computer screen or with special stereoscopic displays, and some simulations include additional sensory information and focus on real sound through speakers or headphones targeted towards virtual reality users. Virtual reality also covers remote communication environments which provide virtual presence of users with the perceptions of telepresence and tele-existence either through the use of standard input devices such as a keyboard and mouse, or through multimodal devices such as via a wired glove or omnidirectional treadmills, for example. The simulated environment can be similar to the real world in order to create lifelike experiences in simulations for pilot or combat training, for example, or it can differ significantly from reality, such as in virtual reality games.

### BRIEF DESCRIPTION OF THE DRAWINGS

FIG. 1 illustrates an example of a block diagram of executable blocks for graphical image augmentation of physical objects.

FIG. 2 illustrates an example system for projecting graphical image augmentation onto physical objects.

FIG. 3 illustrates a system for detecting the presence of a physical object and projecting an image onto the physical object.

FIG. 4 illustrates an example of segmentation engine processing for detecting objects from background information.

FIG. 5 illustrates an example of object position detection a moving object that can be employed by an object position detector.

FIG. 6 illustrates a surface representation of a three dimensional model.

FIG. 7 illustrates dividing three dimensional space into voxels.

FIG. 8 illustrates transforming a three dimensional volumetric model into a surface representation via a marching cubes process.

FIG. 9 illustrates an example of a method for graphical image augmentation of physical objects.

### DETAILED DESCRIPTION

This disclosure relates systems and methods that allow dynamic visual alterations to the appearance of real world objects in real-time for augmented reality and other applications such as live presentations. User interactions can be captured and one or more augmentation images can be dynamically projected onto a physical object in real time, such that the user does not need to wear special glasses or look through a tablet or other display when visualizing projections. The systems and methods can employ depth and/or color sensing to model and track a physical object as it moves in front of a projector and camera system. As an example, a user can virtually paint or render images onto physical objects to change their appearance or to mark-up an object for others to visualize. To enable real time augmentation of physical objects via user renderings, the systems and methods can generate models of the physical object and construct user renderings in real time. Unlike conventional systems, the physical object being projected onto can move dynamically in a spatial region (e.g., a three-dimensional projection space) and thus, need not be static while images are projected onto the object. Since the object is acquired and dynamically modeled when present in the system, the system does not require a priori scanning or initialization of the target object. A user can indicate how they want to virtually modify the object using a variety of methods such as using a laser pointer, for example. For instance, the user can move laser pointer light across the object to virtually paint on the object. System models then identify the location of the laser pointer light on the object and update projected content rendered by the projected light on to the object in real time. Color of the projection can be selected via the same or a different user interface (e.g., touch screen, mouse, keyboard or the like).

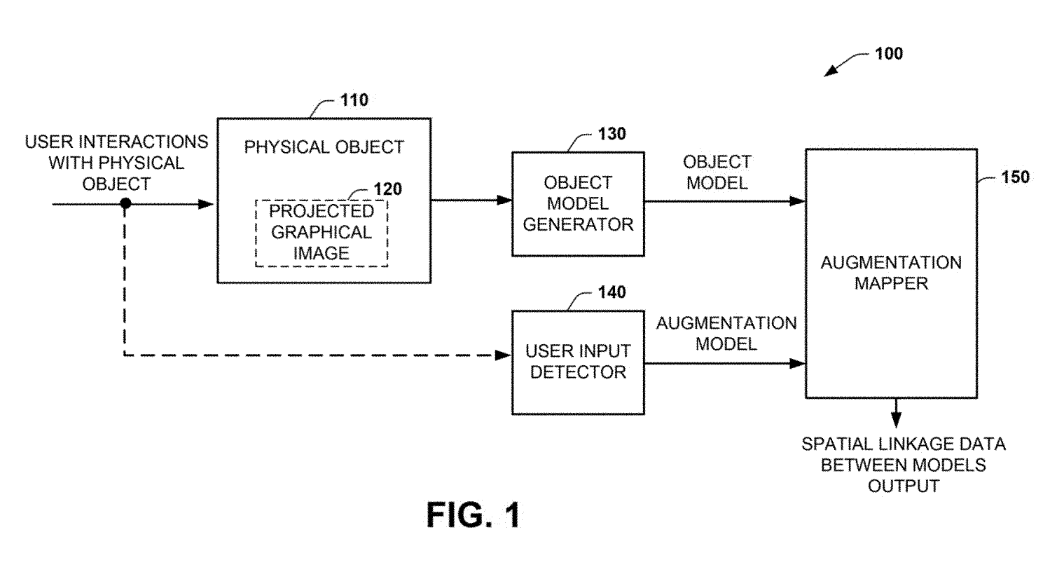

FIG. 1 illustrates an example of a block diagram 100 of executable blocks 130, 140 and 150 for graphical image augmentation of a physical object 110. The executable blocks represented in the diagram 100 can be stored in a non-transitory computer readable medium, which can be accessed and executed by a processing resource (e.g., one or more processing cores). The computer executable instructions can be configured to perform various functions of graphical image augmentation as disclosed herein.

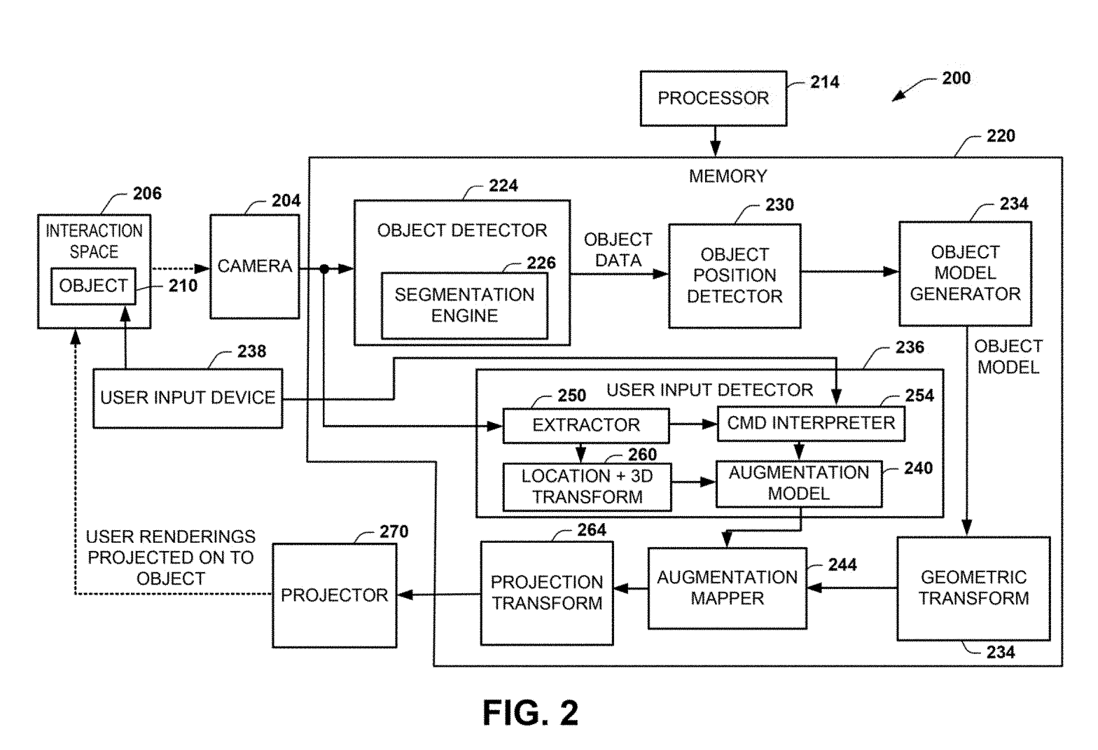

The physical object 110 is interacted with via user interactions (or commands received from an interface). Such user interactions can be captured from images (e.g., RGB images and/or depth images) acquired over time within an interaction space of a processing system such as depicted in the example of FIG. 2. For example, the user interactions can be performed via a user input device, such as a laser light pointer emitting light onto the object 110, in response to finger gesture that, touches or otherwise interacts with the physical object, or using other methods. The user interactions can indicate a desired graphical change to the physical object such as drawing an image on the physical object or changing a global parameter of the physical object such as the texture appearance of the object or the color of the object, for example. The desired graphical change is shown as a projected graphical image 120, which can be projected onto the object residing within an interaction space from a system such as illustrated and described below with respect to FIG. 2.

An object model generator 130 is provided to generate an object model from segmented image data captured from the physical object 110. The object model includes data representing location and geometry of the physical object 110. A user input detector 140 generates an augmentation model that includes data representing a graphical image and location information thereof with respect to the physical object 110 in response to the user interaction associated with the physical object. For example, the user input detector can receive image data acquired by a camera for the interaction space in which the physical object has been placed. The interaction space can be defined by or include a three dimensional spatial region corresponding to the field of view of an image capture device (e.g., a camera).

An augmentation mapper 150 maps the augmentation model to the object model such that the graphical image of the augmentation model is spatially linked to the physical object. As shown output from the augmentation mapper 150 includes spatial linkage data that can be employed by projection blocks (See e.g., FIG. 2) to project a graphical image 120 onto the physical object 110 within the interaction space. The spatial linkage data represents the spatial locations (e.g., two or three-dimensional surface areas) on the physical object 110 that the user interactions occurred and where projected content should be rendered. For example, if the user draws an image (e.g., circle, square, number, picture) onto the physical object 110, the spatial linkages of the augmentation mapper 150 define a spatial location where the user interactions as detected by the user input detector 140 and represented by the augmentation model have occurred with respect to the physical object as represented by the object model. In addition to image graphics, global projections can be made onto the physical object 110 such as changing the color of the physical object and/or changing the texture or pattern of the physical object (e.g., changing the color and/or texture of a shoe). Like the image graphics, global projections are spatially linked to the surface of the physical object 110, such that the global projections remain on the physical object as it moves dynamically within the interaction space.

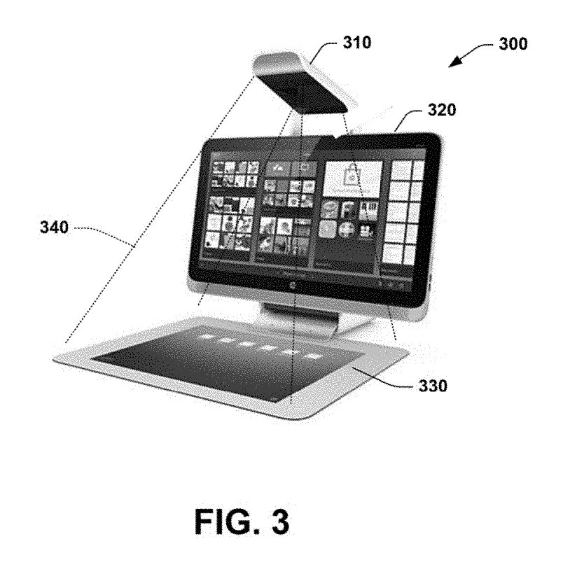

FIG. 2 illustrates an example system 200 for capturing user interactions and projecting graphical image augmentation onto physical objects within an interaction space 206. The system 200 may include a three dimensional camera or other sensor (e.g., multi-camera sensor to sense depth) 204 to capture a three dimensional image of a physical object 210 within the interaction, space. The interaction space 206 can be defined by the field of view of the camera 204 (or cameras) (see, e.g., FIG. 3). For example, the interaction space 206 can correspond to the portion of the camera's field of view that overlaps with a projection space on to which one or more projectors 270 can selectively illuminate.

A processor 214 executes various executable functions from a memory 220. The memory 220 stores non-transitory computer readable instructions that are executed by the processor 214. The memory 220 includes instructions for an object detector 224 that employs a segmentation engine 226 to generate segmented image data by segmenting two- or three-dimensional images of the physical object 210 from background image pixels. An object position detector/tracker 230 detects a position of the physical object 210 (e.g., in the image space) via movement of the segmented three dimensional image pixels as the physical object moves from a first position to a second position. An object model generator 234 generates an object model from the segmented three dimensional image data captured from the physical object 210. The object model includes data (e.g., object geometry or volumetric data) representing location geometry and direction of the physical object as detected by the object position detector 230. As shown, the object model can be geometrically transformed via geometric transform 234 where the transform may include generating a volumetric or geometric representation of the object model.

A user input detector 236 receives input, representing user interactions, and generates an augmentation model 240 that includes data representing a graphical image and location information thereof with respect to the physical object 210 in response to a user interaction associated with the physical object. The augmentation model 240 defines coordinates of the data representing the graphical image and where the data should be projected onto the physical object. The input representing user interactions can be provided from a user input device 238 and/or from the camera 204 as part of the image data. An augmentation mapper 244 maps the augmentation model 240 to the object model such that the graphical image of the augmentation model is spatially linked to the physical object 210.

By way of example, the user input detector 236 can include an extractor 250 to extract user interactions from the input data stream generated by the camera 204. Output from the extractor 250 can be provided to a command interpreter 254 which drives the augmentation model 240. The command interpreter 254 determines whether the user interactions are gestures such as drawing an image or a global command such as indicating changing the color of the physical object 210 or a portion of the physical object. The command interpreter 254 can also receive commands directly from the user input device 238 as shown. Output from the extractor 250 can be processed by a location and three dimensional transform 260 which determines a location and the coordinates for the user interactions with the physical object 210. For instance, the extractor 250 can utilize a pixel threshold to determine light interactions that are above the light levels detected from the object. Output from the augmentation mapper 244 can be provided to a projection transform 264 that provides graphical image coordinates and image pixel data to project user renderings onto the physical object 210. A projector 270 projects the graphical image from the augmentation model 244 and projection transform 264 onto the physical object 210 based on the spatial linkages specified by the augmentation model 244.

The object position detector 230 detects a position (e.g., location and orientation) of the physical object in real time, such as it moves from a first position to a second position. The object position detector 230 determines movement of the physical object 210 by utilizing a correspondence and transformation identifying algorithm such as an iterative closet point (ICP) computation in one example between a first set of points associated with the first position and a second set of points associated with the second position by minimizing an error metric between the first set of points and the second set of points. If movement is detected, the object model can be modified based on the detected position and determined movement of the physical object to maintain the spatial link between the augmentation model 240 and the physical object as the physical object moves from the first position to the second position. The object model generator 234 also divides the volumetric representation of the physical object into pixel voxels that define three dimensional units of pixel image space related to the physical object 210. The object model generator 234 in one example employs a signed distance function to classify each voxel as empty, unseen, or near the surface of a volumetric representation based on a threshold value applied to each voxel. The geometric transform 234 transforms the volumetric representation of the physical object into a geometric representation of the physical object 210. In one example, the geometric transform 234 employs a marching cubes transform to convert the volumetric representation of the physical object 210 into a geometric representation of the physical object. The marching cubes transform creates surface for each voxel detected near the surface of the physical object by comparing each voxel to a table of voxel-image links that connect voxel types to a predetermined geometric representation of the voxel. When a voxel type has been determined, the portion of the volume where the voxel type has been detected can be assigned to the respective geometric type linked by the voxel type.

Input to the system can be received by the 3D camera 204 which generates color and depth image streams of the target area on the physical object 210. An active depth camera can be employed as the camera 204 but passive stereo cameras or other types of sensing technologies are also possible. One processing aspect includes identifying what parts of the view are background objects or surfaces that should be ignored and what parts may be foreground objects to be tracked and reconstructed via the object detector 224 and segmentation engine 226. In one example, the system 200 can assume some initial views of only the background environment without any foreground objects. The objector detector 224 can then generate a per-pixel model using the color and depth streams to enable real-time segmentation of foreground and background objects via the segmentation engine 226. Other processing for background removal is possible, such as assuming a planar surface in the scene comprising the background. Thus, in one example the background image pixels can be captured from a pre-saved image of a background image before image pixels of the physical object appears with the background image. In another example, the background image pixels can be determined dynamically based on ambient sensor data received from the three dimensional camera 204 before the image pixels of the physical object appears before the camera. Motion can also be used to help identify foreground objects. A binary mask can be employed by the segmentation engine 226 to subtract the background image pixels from the image pixels of the physical object 210.

The object position detector 230 determines how the object 210 has moved relative to the previous time instance when it was observed. This motion information is utilized to understand how the object is moving relative to the camera 204 so that a 3D model of the object can be built up over time and the viewpoint relative to the object can be determined. An Iterative Closest Point (ICP) algorithm can be utilized in one example for position detections. Given two sets of points in 3D space, one set from a previous view and another set of 3D points for a current view, ICP computes the transformation (rotation and translation) to align the two sets of points. This transformation corresponds to the motion of the object relative to the camera. Other motion estimation computations are also possible. The object model generator 234 generates a 3D model of the object. The object model generator 234 can update the model over time as the camera 204 acquires new images of the object. A volumetric representation of the object using a Truncated Signed Distance Function (TSDF) technique can be employed to determine the volumetric representation. This merges 3D point cloud data into the volumetric model and updates the object model as desired. For rendering the 3D model (such as for re-projection) it is useful to have an explicit geometric representation suitable for computer graphics display. As mentioned above, the geometric transform 234 can employ a marching cubes computation technique, or other methods, to convert from the volumetric representation to a geometric mesh representation.

The extractor 250 determines where the user is drawing or marking-up the object 210. A laser pointer in one example can be utilized to draw on the object 210. To identify the laser light in the input stream, the extractor identifies the brightest pixels in the color stream that are above a certain threshold and matches expected laser colors. When the 2D location of the laser light has been identified, it can be transformed to the appropriate 3D space for updating the augmentation model 240. The updated augmentation maps from the augmentation mapper 244 are mapped into the relative space of the projector 270 via the projection transform 264 (using the 3D model) and the augmentation is projected onto the object 210.

FIG. 3 illustrates a system 300 for detecting the presence of a physical object and projecting an image onto the physical object within an interaction space 340. One or more camera 310 can be employed to acquire images for detecting the presence of physical objects as described herein. Also, the camera 310 can detect user interactions such as detecting the presence of laser light that has been directed toward the physical object. A projector 320 can be utilized to project one or more augmentation images into the interaction spaced to provide corresponding user renderings, which as described herein that have been spatially linked to the physical object within the interaction space 340. The projections can be 2D or 3D augmented reality projections of the user renderings onto the physical object. An input surface 330 can be provided to detect user commands that are different from those indicated by the laser pointer for example. For example, the input surface can be utilized to specify global commands such as different types of textures or colors that are to be projected onto the physical object.

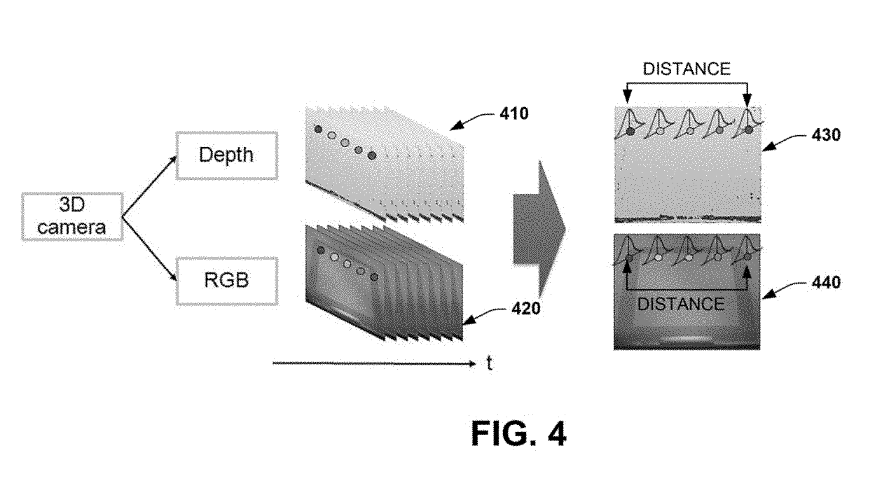

FIG. 4 illustrates an example of segmentation engine 226 processing for detecting objects from background information. Three-dimensional camera information could comprise depth information at 410 and color information (e.g., values for red, green and blue) at 420. The depth and color information can be transformed into Gaussian (or other statistical) representations of each of the depth and color information at 430 and 440, respectively for every pixel. The segmentation engine 226, as described herein, includes instructions that generate the segmented image data by segmenting image pixels of the physical object from background image pixels. In this example, the instructions generate a pixel-wise model that analyzes pixel depth information 410 and pixel color information 420 of the background image pixels received from a three dimensional camera. In one example, the segmentation instructions compute a distance between a point and a distribution of points in the pixel depth information and the pixel color information to determine the background image pixels.

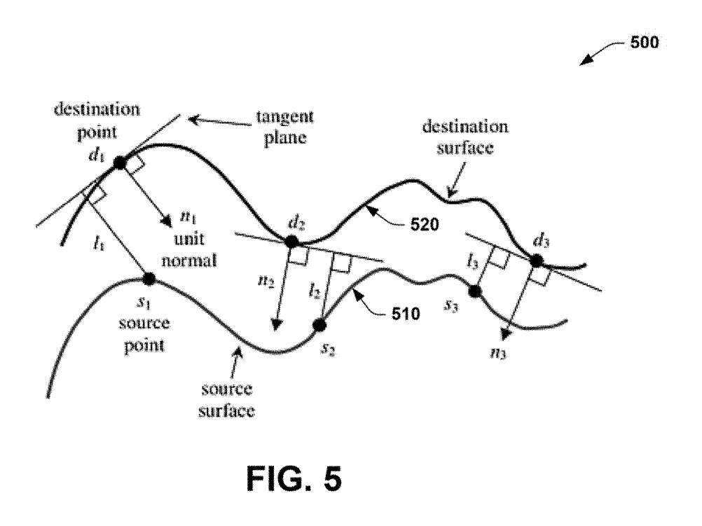

FIG. 5 illustrates an example of object position detection for a moving object that can be employed by an object position detector. As shown, an initial surface is captured shown as a source surface 510 and after the surface has moved, a destination surface is shown at 520. Each surface can be described via source and destination points, tangent planes, and vector such as normal vectors shown as n1, n2, and n3. The object position detector can include instructions to detect a position of the physical object as it moves from a first position to a second position (and subsequent positions). The instructions determine movement of the physical object utilizing an iterative closet point (ICP) computation in one example between a first, set of points associated with the first position and a second set of points associated with the second position by minimizing an error metric between the first set of points and the second set of points. For example, the error metric can be computed as follows:

$$E = {\sum }_{i = 1}^{N} {‖ {n}_{i}^{⊤} ( {Rp}_{i} + t - {q}_{i} ) ‖}^{2}$$

where E is the error metric,
N is the Number of points to compare,
nᵢ is the unit normal for point i,
T is the transpose of a vector.
R is the Rotation matrix,
pi is the 3D point location for point i in a previous frame,
t is the translation matrix, and
qᵢ is the 3D point location for point i in a current frame.

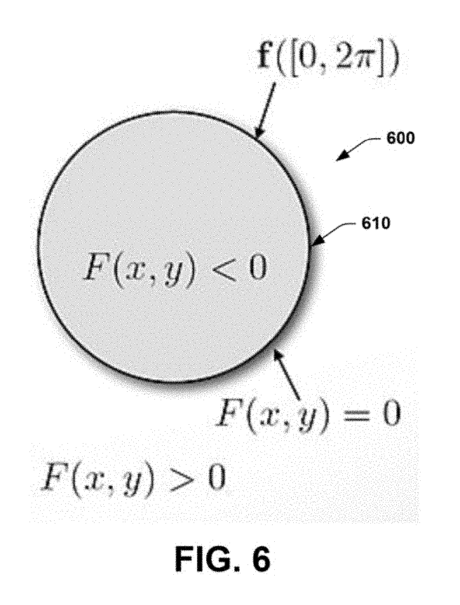

FIG. 6 illustrates a surface representation 600 of a three dimensional model and can be employed by the object model generator described herein to generate an object model from the respective surface representation. In this example, a function of a circle is represented but substantially any type of surface function is possible (e.g., square, triangle, rectangle, complex shape, and so forth). The volumetric representation described herein for the object model can be generated as a three dimensional surface representation of the three dimensional model. The volumetric representation may include an explicit function (e.g., f(x) defining a range of parameterization for pixels (e.g., 0 to 2 pi) associated with a surface 610 of the physical object or an implicit function that employs a signed distance function to update pixels at a given distance to the surface of the physical object. The implicit function (e.g., F(x,y)) employs a signed distance function (e.g., square root of sum of the squares) to update pixels at a given distance to the surface 610 of the physical object. As shown, the implicit function F(x,y) can be defined inside the surface 610 (e.g., F(x,y)<0), at the surface 610 (e.g., F(x,y)=0) and outside the surface 610 (e.g., F(x,y)>0).

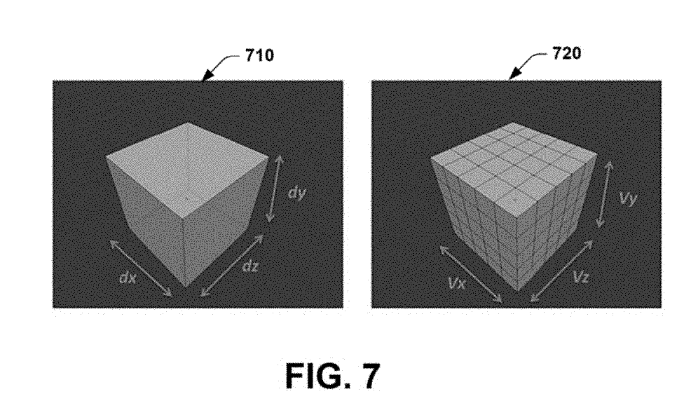

FIG. 7 illustrates dividing three dimensional space (e.g., corresponding to the interaction space) into voxels. As used herein, the term voxel represents a value on a regular grid in three-dimensional space. As with pixels in a bitmap, voxels themselves do not typically have their position (their coordinates) explicitly encoded along with their values. Instead, the position of a voxel is inferred based upon its position relative to other voxels (e.g., its position in the data structure that makes up a single volumetric image). In contrast to pixels and voxels, points and polygons are often explicitly represented by the coordinates of their vertices. A single voxel is shown at 710 and a cube of voxels is shown at 720. Other geometric shapes than cubes are possible. The object model generator described herein can include instructions that divide the volumetric representation of the physical object into pixel voxels that define three dimensional units of pixel image space related to the physical object. The instructions employ the truncated signed distance function in one example to classify each voxel as empty, unseen, or near the surface of the volumetric representation based on a threshold value applied to each voxel. Based on such classification, the exterior of the surface of the physical object can be modeled to determine the coordinates where to render an augmentation image onto the actual physical object.

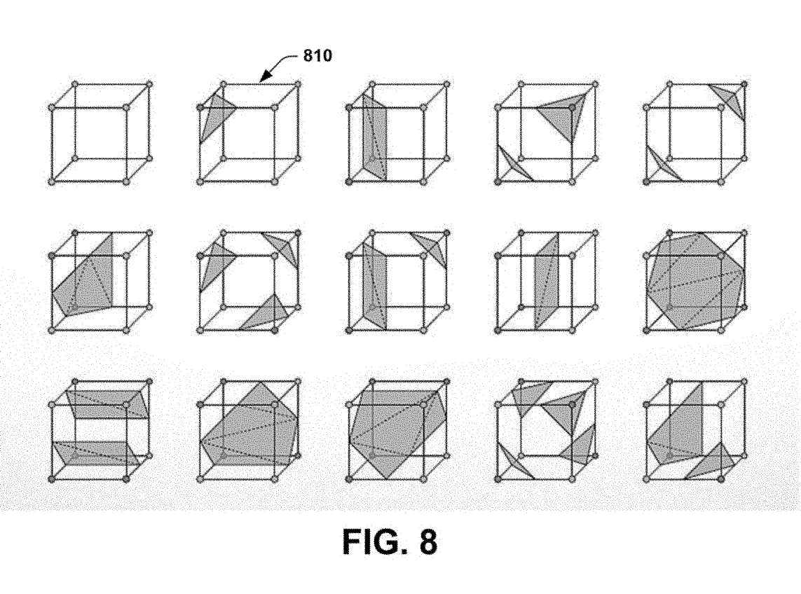

FIG. 8 illustrates transforming a three dimensional volumetric model into a surface representation via a marching cubes process. In this example, the cubes such as shown at 810 can be processed by the geometric transforms described herein to generate geometric models for the user interactions and renderings to be projected. The geometric transform includes instructions to transform the volumetric representation of the physical object into a geometric representation of the physical object. The geometric transform instructions employ a marching cubes transform to convert the volumetric representation of the physical object into a geometric representation of the physical object. The marching cubes creates a surface for each voxel detected near the surface of the physical object by comparing each voxel to a table of voxel-image links such as the examples depicted in FIG. 8 that connect voxel types to a predetermined geometric image of the voxel.

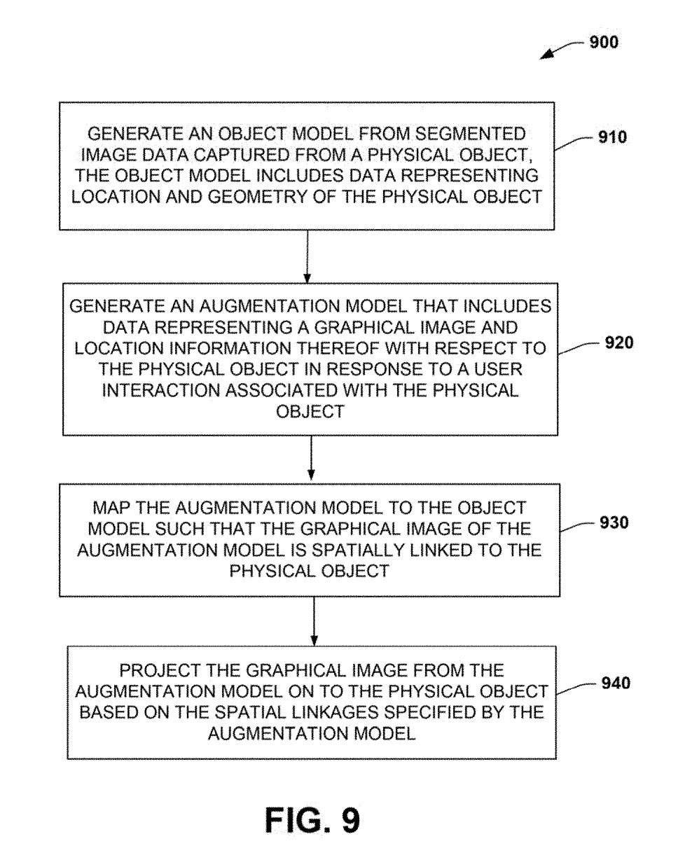

In view of the foregoing structural and functional features described above, an example method will be better appreciated with reference to FIG. 9. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components and executed by an integrated circuit, computer, or a controller, for example.

FIG. 9 illustrates an example of a method 900 for graphical image augmentation of physical objects. At 910, the method 900 includes generating an object model from segmented image data captured from a physical object (e.g., via object model generator 130 of FIG. 1). The object model includes data representing location and geometry of the physical object. At 920, the method 900 includes generating an augmentation model that includes data representing a graphical image and location information thereof with respect to the physical object in response to a user interaction associated with the physical object (e.g., via user input detector 140 of FIG. 1). At 930, the method 900 includes mapping the augmentation model to the object model such that the graphical image of the augmentation model is spatially linked to the physical object (e.g., via augmentation mapper 150 of FIG. 1). At 940, the method 900 includes projecting the graphical image from the augmentation model on to the physical object based on the spatial linkages specified by the augmentation model (e.g., via projector 270 of FIG. 2). Although not shown, the method 900 can also include detecting a position of the physical object as it moves from a first position to a second position utilizing an iterative closet point (ICP) computation between a first set of points associated with the first position and a second set of points associated with the second position by minimizing an error metric between the first set of points and the second set of points.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element neither requiring nor excluding two or more such elements. As used herein; the term “includes” means includes but not limited to, and the term “including” means including but not limited to. The term “based on” means based at least in part on.

What is claimed is:

1. A non-transitory computer readable medium having computer executable instructions stored thereon, the computer executable instructions configured to:
generate an object model from image data captured from a physical object, the object model includes data representing location and geometry of the physical object;
generate an augmentation model that includes data representing a graphical image and location information thereof with respect to the physical object in response to a user interaction associated with the physical object; and
map the augmentation model to the object model such that the graphical image of the augmentation model is spatially linked to the physical object.

2. The computer readable medium of claim 1, further comprising instructions to
generate the segmented image data by segmenting image pixels of an interaction space that includes the physical object and background image pixels,
generate a pixel-wise model that analyzes pixel depth information and pixel color information of the background image pixels acquired by a camera, and
compute a distance between a given point and a distribution of points in the pixel depth information and the pixel color information to determine the background image pixels.

3. The computer readable medium of claim 2, wherein the background image pixels are captured from a corresponding image of a background image space before acquiring image pixels of the physical object and background image within the interaction space, or the background image pixels are determined dynamically based on ambient sensor data received from the three dimensional camera before the image pixels of the physical object appears before the camera, the instructions further to subtract the background image pixels from the image pixels of the physical object.

4. The computer readable medium of claim 1, further comprising instructions to:
detect a position of the physical object as it moves from a first position to a second position, and
determine movement of the physical object utilizing a correspondence and transformation identifying algorithm computation between a first set of points associated with the first position and a second set of points associated with the second position by minimizing an error metric between the first set of points and the second set of points.

5. The computer readable medium of claim 4, further comprising modifying the object model based on the detected position and determined movement of the physical object to maintain the spatial link between the augmentation model and the physical object as the physical object moves from the first position to the second position.

6. The computer readable medium of claim 1, further comprising instructions to generate a three dimensional model of the physical object, the three dimensional model generated as a volumetric representation of the physical object, the volumetric representation generated as three dimensional surface representation of the three dimensional model, the volumetric representation including an implicit function defining a range of parameterization for pixels associated with the surface of the physical object.

7. The computer readable medium of claim 6, wherein the instructions divide the volumetric representation of the physical object into pixel voxels that define three dimensional units of pixel image space related to the physical object, the instructions employ a signed distance function to classify each voxel as empty, unseen, or near the surface of the volumetric representation based on a threshold value applied to each voxel.

8. The computer readable medium of claim 7, wherein the instructions further comprise geometric transform instructions to transform the volumetric representation of the physical object into a geometric representation of the physical object, the geometric transform instructions employ a marching cubes transform to convert the volumetric representation of the physical object into a geometric representation of the physical object, the marching cubes creates surface geometry for each voxel detected near the surface of the physical object by comparing each voxel to a table of voxel-image links that connect voxel types to a predetermined geometric representation of the voxel.

9. The computer readable medium of claim 1, further comprising instructions to detect pixels that are above a given threshold to determine the user interaction, with the physical object.

10. A system, comprising:
a camera to capture an image of a three-dimensional interaction space that contains at least one physical object;
a processor and memory, the memory storing non-transitory computer readable instructions that are executed by the processor, the computer readable instructions comprising:
an object detector that employs a segmentation engine to generate segmented image data by segmenting image pixels of the physical object from background image pixels;
an object position detector to detect a position of the physical object via movement of the segmented three dimensional image pixels as the physical object moves within the interaction space;
an object model generator to generate an object model from the segmented three dimensional image data captured from the physical object, the object model includes data representing location and geometry of the physical object as detected by the object position detector;
a user input detector to generate an augmentation model that includes data representing a graphical image and location information thereof with respect to the physical object in response to user interaction associated with the physical object;
an augmentation mapper to map the augmentation model to the object model such that the graphical image of the augmentation model is spatially linked to the physical object; and
a projector to project the graphical image of the augmentation model on to the physical object based on the spatial linkages specified by the augmentation model.

11. The system of claim 10, wherein the object model detector detects a position of the physical object as it moves from a first position to a second position, the object model detector determines movement of the physical object utilizing a correspondence and transformation identifying computation between a first set of points associated with the first position and a second set of points associated with the second position by minimizing an error metric between the first set of points and the second set of points.

12. The system of claim 10, wherein the object model generator divides the volumetric representation of the physical object into pixel voxels that define three dimensional units of pixel image space related to the physical object, the object model generator employs a signed distance function to classify each voxel as empty, unseen, or near the surface of a volumetric representation based on a threshold value applied to each voxel.

13. The system of claim 10, wherein the computer readable instructions further comprise a geometric transform to transform the volumetric representation of the physical object into a geometric representation of the physical object, the geometric transform employs a marching cubes transform to convert the volumetric representation of the physical object into a geometric representation of the physical object, the marching cubes transform to create a visible image surface of each voxel detected near the surface of the physical object by comparing each voxel to a table of voxel-image links that connect voxel types to a predetermined geometric image of the voxel.

14. A method, comprising:
generating an object model from segmented image data captured from a physical object, the object model includes data representing location and geometry of the physical object;
generating an augmentation model that includes data representing a graphical image and location information thereof with respect to the physical object in response to a user interaction associated with the physical object;
mapping the augmentation model to the object model such that the graphical mage of the augmentation model is spatially linked to the physical object; and
projecting the graphical image from the augmentation model on to the physical object based on the spatial linkages specified by the augmentation model.

15. The method of claim 14, detecting a position of the physical object as it moues from a first position to a second position utilizing an iterative closet point (ICP) computation between a first set of points associated with the first position and a second set of points associated with the second position by minimizing an error metric between the first set of points and the second set of points.
